(19) United States
(12) Patent Application Publication
(10) Pub. No.: US 2024/0049698 A1
(43) Pub. Date: Feb. 15, 2024

(54) VEHICLE

(71) Applicant: TOYOTA JIDOSHA KABUSHIKI KAISHA, Aichi-ken (JP)

(72) Inventors: Kenji SUZUKI, Tokyo-to (JP); Satoru TANAKA, Yokohama-shi (JP); Yukihiko IDESHIO, Nisshin-shi (JP); Keisuke IUCHI, Anjo-shi (JP); Masanobu TANIMOTO, Nagoya-shi (JP)

(21) Appl. No.: 18/366,611

(22) Filed: Aug. 7, 2023

(30) Foreign Application Priority Data
Aug. 10, 2022 (JP) 2022-128484

(51) Int. Cl. A01M 7/00; A01B 69/00; A01B 69/04; G06T 7/00; G06V 20/10; G06V 20/56; G06V 10/82

(52) U.S. Cl. CPC A01M 7/0089; A01B 69/001; A01B 69/008; G06T 7/0012; G06V 20/188; G06V 20/56; G06V 10/82; G06T 2207/20081; G06T 2207/20084; G06T 2207/30188; G06T 2207/30252

(57) ABSTRACT

A vehicle for spraying an agrochemical to an object to be controlled. The vehicle includes: a photographing device configured to photograph the object around the vehicle; a control device configured to make a determination as to whether or not the agrochemical needs to sprayed to the object, based on an image of the object acquired when the object was photographed; and a spraying device configured to spray the agrochemical to the object when determining that the agrochemical needs to be sprayed to the object. The photographing device is configured to photograph the object from a lower end of the object to an upper end of the object in a vertical direction of the object.

This application claims priority from Japanese Patent Application No. 2022-128484 filed on Aug. 10, 2022, the disclosure of which is herein incorporated by reference in its entirety.

### FIELD OF THE INVENTION

The present invention relates to vehicle for spraying an agrochemical to an object to be controlled.

### BACKGROUND OF THE INVENTION

There is well known a system for spraying an agrochemical to an object to be controlled. For example, an agricultural support system described in Patent Document 1 is such a system. Patent Document 1 discloses the agricultural support system including a photographing device, a control device, and a spraying device. The photographing device of Patent Literature 1 is a device which is provided in an unmanned flying object such as a multicopter and which photographs a plantation. The control device of Patent Literature 1 is a device that calculates a growth state of crops in the plantation using an image captured by the photographing device, then estimates occurrence of pests based on the calculated growth state, and then creates a work plan related to application or spray of the agrochemical based on the estimated occurrence. The spraying device of Patent Document 1 is a device for spraying the agrochemical to the plantation where the occurrence of the pests is estimated.

### PRIOR ART DOCUMENTS

### Patent Documents

[Patent Document 1]
Japanese Patent Application Laid-Open No. 2021-106554

### SUMMARY OF THE INVENTION

A system for spraying an agrochemical to an object to be controlled needs to have functions such as photographing the object to be controlled, determining whether or not to spray the agrochemical, and spraying the agrochemical. In the agricultural support system described in Patent Literature 1, the devices that realize the respective functions described above are separately provided. In such an agricultural support system, after the entire area of a target plantation is photographed, it is determined whether or not application or spray of the agrochemical is necessary for each area in the plantation, and the agrochemical is applied to a necessary area based on the determination result. There is room for improvement in the application of the agrochemical. In addition, in a case where the object to be controlled is a tall object such as a fruit tree, if a height position in which the object is photographed is uniformly set, there is a possibility that the agrochemical cannot be efficiently sprayed.

The present invention has been made in view of the above circumstances, and an object of the present invention is to provide a vehicle capable of efficiently spraying an agrochemical.

According to a first aspect of the present invention, there is provided a vehicle for spraying an agrochemical to an object to be controlled. The vehicle includes: a photographing device configured to photograph the object around the vehicle; a control device configured to make a determination as to whether or not the agrochemical needs to sprayed to the object, based on an image of the object acquired when the object was photographed; and a spraying device configured to spray the agrochemical to the object when it is determined that the agrochemical needs to be sprayed to the object. The photographing device is configured to photograph the object from a lower end of the object to an upper end of the object in a vertical direction of the object.

According to another aspect of the invention, in the vehicle according to the first aspect of the invention, the control device is configured to make the determination as to whether or not the agrochemical needs to sprayed to the object, by applying the data of the image used for the determination, to a predefined learning model which is established by a supervised learning by a machine learning and which indicates a relationship between the data of the image and necessity of spray of the agrochemical to the object.

According to the first aspect of the present invention, since the vehicle for spraying the agricultural to the object to be controlled is provided with the photographing device for photographing the object around the vehicle, the control device for determining whether or not the spray of the agrochemical is necessary, and the spraying device for spraying the agrochemical, the estimation and the control of the pests can be performed at the same time. Further, since the photographing device photographs the object around the vehicle from the lower end to the upper end in the vertical direction, even where the agrochemical is sprayed to a tall object such as a fruit tree, the vehicle can estimate and control pests at the same time. Therefore, the agrochemical can be sprayed efficiently.

Further, according to the another aspect of the invention, it is determined whether or not the spray of the agrochemical is necessary by applying the data of the image used for the determination of the necessity of the spray of the agrochemical, to the learning model which is established by the supervised learning through the machine learning and which indicates the relationship between the data of the image and the necessity of the spray of the agrochemical. Thus, it is possible to determine whether or not the agrochemical needs to be sprayed by a visual difference close to an artificial determination method.

### BRIEF DESCRIPTION OF THE DRAWINGS

FIG. 1 is a view for explaining a schematic configuration of a vehicle to which the present invention is applied, and for explaining an appearance of the vehicle during work.

FIG. 2 is a view for explaining a schematic configuration of a vehicle to which the present invention is applied, and for explaining main parts of various control functions and a control system in the vehicle.

FIG. 3 is a view showing an example of a color hue difference among a plurality of regions of an object image.

FIG. 4 is a set of views, wherein the view (a) shows an example of the object image in which a predetermined region requiring spray of an agrochemical is specified, and the view (b) shows an example of a corrected object image.

FIG. 5 is a view showing an example of a learning model.

FIG. 6 is a flowchart for explaining a main part of a control routine executed by an electronic control device, for efficiently spraying the agrochemical.

### DETAILED DESCRIPTION OF PREFERRED EMBODIMENT

An embodiment of the present invention will be described in detail below with reference to the drawings.

### EMBODIMENT

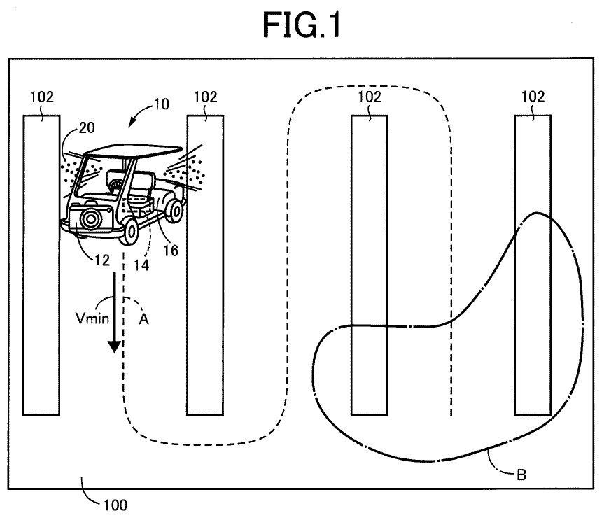

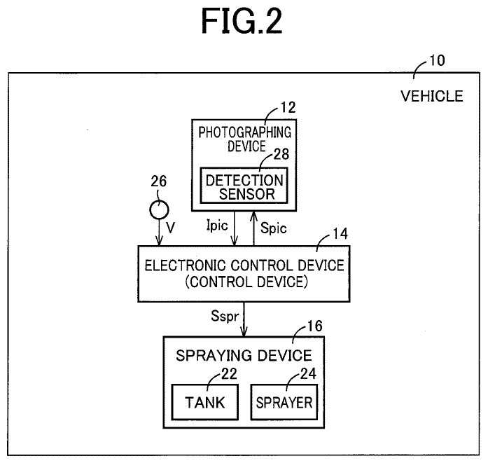

FIGS. 1 and 2 show a schematic configuration of a vehicle 10 to which the present invention is applied. FIG. 1 is a view for explaining an appearance of the vehicle 10 during work. FIG. 2 is a view for explaining main parts of various control functions and a control system in the vehicle 10.

The vehicle 10 is, for example, a known electric vehicle capable of automatic driving. The vehicle 10 autonomously travels in an unmanned manner on a predetermined route (see a broken line A in FIG. 1) in a plantation 100. The vehicle 10 is a vehicle that applies or sprays an agrochemical 20 to an object 102 to be controlled in the plantation 100. The plantation 100 is a plantation such as an orchard. The object 102 is constituted by crops such as fruit trees cultivated in the plantation 100. The crop include leaves or the like in addition to fruits. The object 102, which is cultivated, is sectioned into a plurality of sections that are arranged at a predetermined interval so as to form a row, for example. The object 102 is constituted by the crops that are subjected to prevention and extermination of pests. The pests are diseases and pests of the crops. The agrochemical 20 is a known agrochemical. The vehicle 10 may be an engine vehicle, may perform manned traveling by automatic driving, or may be a vehicle capable of manual driving.

The vehicle 10 includes a photographing device 12, an electronic control device 14 and a spraying device 16.

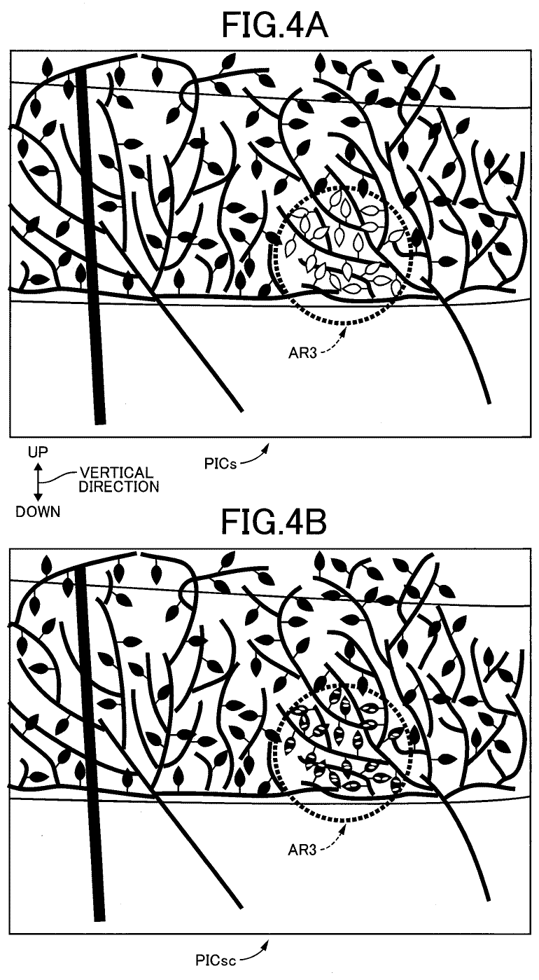

The photographing device 12 is provided, for example, in a front portion of the vehicle 10 in a longitudinal direction of the vehicle 10. The photographing device 12 is, for example, a monocular camera that photographs surroundings of the vehicle 10. The photographing device 12 photographs the object 102 around the vehicle 10, in particular, in front of or on the side of the vehicle 10. The photographing device 12 outputs an image information Ipic that is information of an object image PICs to the electronic control device 14. The object image PICs is an image PIC acquired when the object 102 is photographed when the agrochemical 20 is to be applied or sprayed to the object 102, and is an image PIC that is to be used for a determination as to whether or not the object 102 need to be sprayed with the agrochemical 20 (see FIG. 4 (a) described later).

The spraying device 16 is provided, for example, in a rear portion of the vehicle 10 in the longitudinal direction. The spraying device 16 includes a tank 22 for storing the agrochemical 20, and a sprayer 24 for spraying the agrochemical 20. The spraying device 16 sprays the agrochemical 20 to the object 102.

The electronic control device 14 is a control device, that is, a controller of the vehicle 10 related to running of the vehicle 10 and controls of the photographing device 12 and the spraying device 16, for example. The electronic control device 14 includes, for example, a so-called microcomputer including a CPU, a RAM, a ROM, an input/output interface. The CPU executes various controls of the vehicle 10 by performing signal processing in accordance with a program pre-stored in the ROM while using a temporary storage function of the RAM.

The image information Ipic is supplied from the photographing device 12 to the electronic control device 14. Various signals and the like (e.g., a vehicle running speed V) based on detected values detected by various sensors and the like (e.g., a running speed sensor 26) provided in the vehicle 10 are supplied to the electronic control device 14. A photographing command signal Spic for photographing the object 102 around the vehicle 10 is outputted from the electronic control device 14 to the photographing device 12. In addition, a spraying command signal Sspr for spraying the agrochemical 20 to the object 102 is outputted from the electronic control device 14 to the spraying device 16. A control command signal for automatic driving is outputted from the electronic control device 14 to each device (not shown) provided in the vehicle 10.

The photographing device 12 photographs the object 102 around the vehicle 10 based on the photographing command signal Spic from the electronic control device 14, and outputs the image information Ipic including information of the object image PICs to the electronic control device 14. The electronic control device 14 makes a determination as to whether or not the agrochemical 20 needs to be applied or sprayed to the object 102, based on the object image PICs included in the acquired image information Ipic. When determining that the agrochemical 20 needs to be sprayed to the object 102, the electronic control device 14 outputs the spraying command signal Sspr for spraying the agrochemical 20 to the object 102 corresponding to the object image PICs included in the acquired image information Ipic, such that the outputted spraying command signal Sspr is supplied to the spraying device 16. Based on the spraying command signal Sspr from the electronic control device 14, the spraying device 16 sprays the agrochemical 20 to the object 102 for which spray of the agrochemical 20 is determined to be necessary.

By the way, in a case where the object 102 to be controlled is a tall object such as a fruit tree, if a height position in the object 102 is photographed by the photographing device 12 is set to a constant height, there is a risk that the agrochemical 20 could not be efficiently sprayed.

Therefore, the photographing device 12 includes a detection sensor 28 such as a lidar or an infrared sensor that detects the object 102 to be controlled around the vehicle 10. The photographing device 12 detects a length or height of each object 102 in a vertical direction of the object 102 through the detection sensor 28 when the vehicle 10 runs when the agrochemical 20 is to be sprayed. For example, the photographing device 12 detects a position in which the object 102 is located, through the detection sensor 28 when the vehicle 10 runs for spraying the agrochemical 20. The photographing device 12 photographs the object 102 from its lower end to its upper end in the vertical direction when the vehicle 10 runs for spraying the agrochemical 20.

As the running speed V during running of the vehicle 10 is higher, the object image PICs is more likely to become unclear, and it is more difficult to determine whether or not the agrochemical 20 needs to be sprayed. When the agrochemical 20 is sprayed, it is preferable that the vehicle 10 runs at a speed within a clear-image enabling range which is a predetermined range Vpic of the running speed V and which enables the photographing device 12 to take the object image PICs clearly. Further, in order to efficiently spray the agrochemical 20, it is preferable that the vehicle 10 runs at a highest value Vpicmax of the predetermined range Vpic of the running speed V.

On the other hand, the higher the vehicle speed V during running of the vehicle 10 is, the more difficult the agrochemical 20 is to be appropriately sprayed to the object 102. When spraying the agrochemical 20, the vehicle 10 preferably runs at a speed within an appropriate-agrochemical-spray enabling range which is a predetermined range Vspr of the running speed V and which enables the spraying device 16 to appropriately spray the agrochemical 20 to the object 102. Further, in order to efficiently spray the agrochemical 20, it is preferable that the vehicle 10 runs at a highest value Vsprmax of the predetermined range Vspr of the running speed V.

A lower one of the highest value Vpicmax of the predetermined range Vpic of the running speed V and the highest value Vsprmax of the predetermined range Vspr of the running speed V may be selected so that the spray of the agrochemical 20 is performed most efficiently in a vehicle speed range in which the necessity of spray of the agrochemical 20 can be determined and the agrochemical 20 can be applied appropriately. That is, when spraying the agrochemical 20, the car 10 runs at a lower running speed Vmin that is the lower one of the highest value Vpicmax of the predetermined range Vpic of the running speed V and the highest value Vsprmax of the predetermined range Vspr of the running speed V, as an upper limit of the running speed V (see FIG. 1). For example, the electronic control device 14 outputs a control command signal for performing automatic driving at the lower running speed Vmin as the upper limit of the running speed V, to each device (not illustrated) provided in the vehicle 10. It is noted that the highest value Vpicmax of the predetermined range (clear-image enabling range) Vpic of the running speed V corresponds to “first maximum speed value” recited in the appended claims, and that the highest value Vsprmax of the predetermined range (appropriate-agrochemical-spray enabling range) Vspr of the running speed V corresponds to “second maximum speed value” recited in the appended claims.

The determination of whether or not the spray of the agrochemical 20 by the electronic control device 14 is necessary will be described in detail. For example, the electronic control device 14 performs predetermined image processing on the object image PICs, and calculates a color hue difference Dt between a color hue of the object 102 (e.g., leaves) in a predetermined region AR and a color hue in the normal state. As the color hue in the normal state, for example, a predetermined color hue, an average color hue of the object 102 in the plantation 100, an average color hue of the object 102 outside the predetermined region AR of the object image PICs, or the like is used. The electronic control device 14 determines whether or not the spray of the agrochemical 20 is necessary based on whether or not the color hue difference Dt in the predetermined region AR of the object image PICs is equal to or greater than a necessity determination value THn. Determining whether or not the spray of the agrochemical 20 is necessary based on whether or not the color hue difference Dt is equal to or greater than the necessity determination value THn, is the same as estimating whether or not the pests have emerged based on whether or not the color hue difference Dt is equal to or greater than the necessity determination value THn. The necessity determination value THn is, for example, a predetermined agrochemical spray necessity determination value for determining that the color hue difference Dt is so large that spray of the agrochemical 20 is necessary. When the electronic control device 14 determines that the color hue difference Dt in the predetermined region AR is equal to or greater than the necessity determination value THn, the electronic control device 14 determined that the agrochemical 20 needs to be sprayed to the predetermined region AR.

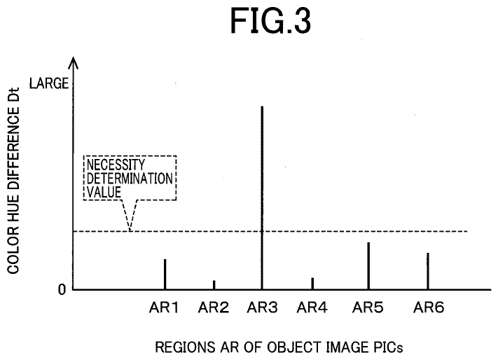

FIG. 3 is a view illustrating an example of the color hue difference Dt among a plurality of regions AR of the object image PICs. FIG. 4 (a) is a view showing an example of the object image PICs in which the predetermined region AR to which the agrochemical 20 needs to be sprayed is specified. In FIG. 3, the color hue difference Dt in a third predetermined region AR3 is equal to or greater than the necessity determination value THn. As shown in FIG. 4 (a), the third predetermined region AR3 is specified as the region to which the agrochemical 20 needs to be sprayed.

A situation ST when the object 102 is photographed by the photographing device 12 is not constant. The situation ST at the time of photographing varies depending on various factors such as brightness around the vehicle 10, type of the object 102, growth state of the object 102, health state of the object 102 and location of the plantation 100. The brightness around the vehicle 10 varies depending on season, timeframe, weather condition, and presence or absence of shadow, for example.

The electronic control device 14 stores a predetermined reference image PICb as the image PIC when the object 102 is photographed by the photographing device 12 in a predetermined reference situation STf. The electronic control device 14 corrects the object image PICs based on a difference between the reference situation STf in which the object 102 was photographed to acquire the reference image PICb and an actual situation STs in which the object 102 was photograph to take the object image PICs that is to be used for the determination as to whether or not the agrochemical 20 needs to be sprayed to the object 102. For example, the electronic control device 14 corrects the object image PICs through a predetermined image correction process, depending on a difference between the reference situation STf and the actual situation STs. In this embodiment, the corrected object image PICs is referred to as a post-correction object image PICsc (see FIG. 4 (b)). The electronic control device 14 determines whether or not the agrochemical 20 needs to sprayed to the object 102, based on the corrected object image PICsc. For example, the electronic control device 14 determines whether or not the spray of the agrochemical 20 is necessary based on whether or not the color hue difference Dt of the corrected object image PICsc in the predetermined region AR is equal to or greater than the necessity determination value THn. In this case, the electronic control device 14 only needs to store the reference situation STf and does not need to store the predetermined reference image PICb, for correcting the object image PICs. Alternatively, the electronic control device 14 may determine whether or not the spray of the agrochemical 20 is necessary based on the difference between the predetermined reference image PICb and the corrected object image PICsc. For example, the electronic control device 14 may determine whether or not the spray of the agrochemical 20 is necessary based on whether or not the color hue difference Dt between the hue in the reference image PICb and the color hue in the corrected object image PICsc is equal to or greater than the necessity determination value THn.

In the determination made by the electronic control device 14 as to whether or not the spray of the agrochemical 20 is necessary, for example, a learning model 30 based on a machine learning may be used. For example, the electronic control device 14 applies the object image PICs to the learning model 30 to determine whether or not the agrochemical 20 needs to be sprayed. The learning model 30 is a predetermined learned model indicating a relationship between the data of the image PIC and the necessity of spray of the agrochemical 20. The learning model 30 is established by a supervised learning through a machine learning using the data of the image PIC and the necessity of spray of the agrochemical 20 as training data. The necessity of spray of the agrochemical 20 may be replaced with the presence or absence of occurrence of the pests.

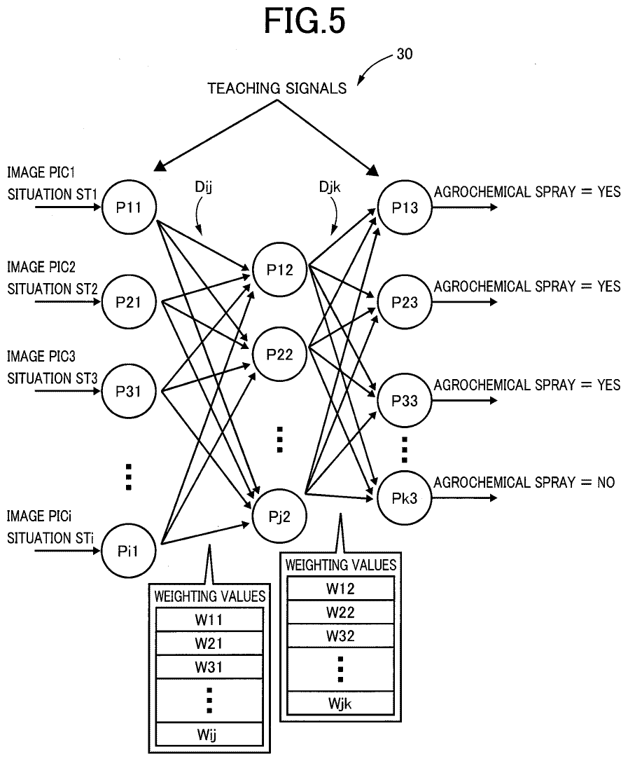

FIG. 5 is a view showing an example of the learning model 30. In FIG. 5, the learning model 30 is a neural network based on the data of the image PIC and the situation ST in which the object 102 was photograph to acquire the image PICs. The learning model 30 can be configured by modeling a neuronal group of a living body by a software based on a computer program or by a hardware composed of a combination of electronic elements. The learning model 30 has a multilayer structure including an input layer including i neuronal elements (=neurons) Pil, an intermediate layer including j neuronal elements Pj2, and an output layer including k neuronal elements Pk3. The intermediate layer may have a multilayer structure. In the learning model 30, a transfer element Dij having a weighting value Wij and a transfer element Djk having a weighting value Wjk are provided in order to transfer a state of the neuronal element from the input layer toward the output layer. The transfer elements Dij are transfer elements for coupling the i neuronal elements Pi 1 and the j neuronal elements Pj2. The transfer elements Djk are transfer elements for coupling the j neuronal elements Pj2 and the k neuronal elements Pk3.

The learning model 30 is a necessity determination system that determines whether or not the agrochemical 20 needs to be sprayed. The necessity determination system is also a pest estimation system. In the learning model 30, the weighting values Wij and Wjk are machine-learned by a predetermined algorithm. In the supervised learning in the learning model 30, training data, i.e., teaching signals specified in the vehicle 10 are used. In the learning model 30 of FIG. 5, for example, data of the image PIC and data of the situation ST in which the object 102 was photographed are given as the teaching signals for the input layer. In the learning model 30 of FIG. 5, the determination result of whether or not the agrochemical 20 needs to be sprayed, i.e., the estimation result of the presence or absence of pests is given as the teaching signals for the output layer. The electronic control device 14 determines whether or not the spray of the agrochemical 20 is necessary by applying the object image PICs and the actual situation STs in which the object 102 was photographed to take the object image PICs (that is to be used for the determination as to whether or not the agrochemical 20 needs to be sprayed), to the learning model 30 of FIG. 5. Where the learning model 30 of FIG. 5 is used, since the situation ST in which the object 102 is captured is also learned, it is not necessary to correct the object image PICs.

The learning model 30 may be a predetermined learned model indicating the relationship among the data of the image PIC, the necessity of spray of the agrochemical 20, the type of pests that have emerged in the object 102, and the degree of progress of damage caused by the pests. In other words, the learning model 30 may further indicate the relationship among the data of the image PIC, the type of pests that have occurred in the object 102, and the degree of progress of damage caused by the pests. In this case, as the teaching signals for the output layer composed of the k neuronal elements Pk3 in FIG. 5, in addition to the determination result of whether or not the agrochemical 20 needs to be sprayed, the determination result of the type of the pests that has occurred in the object 102 and the degree of progress of the damage by the pests are given. The type of pests is, for example, a disease name such as “downy mildew”. The degree of progress of damage by the pests is, for example, “small”, “medium”, or “large”. The determination result of the type of the pests and the progress degree of the damage caused by the pests are given to, for example, the output layer in which it is determined that the spray of the agrochemical 20 is necessary. By applying the object image PICs to the learning model 30, the electronic control device 14 determines whether or not the agrochemical 20 needs to be sprayed, and also determines the type of the pests and the degree of progress of damage caused by the pests. The electronic control device 14 determines a type and a required amount of the agrochemical 20 based on the determined type of the pests and the progress degree of the damage by the pests. The type of the agrochemical 20 may be, for example, a Bordeaux liquid in case of the “downy mildew”. The required amount of the agrochemical 20 may be, for example, a dilution ratio and an application amount of the agrochemical 20. The spraying command signal Sspr outputted by the electronic control device 14 includes the type and the required amount of the agrochemical 20 in addition to the spray of the agrochemical 20 to the object 102 to be controlled. Based on the spraying command signal Sspr from the electronic control device 14, the spraying device 16 applies only the required amount of the agrochemical 20 corresponding to the pests, to the object 102 determined to require spray of the agrochemical 20.

The electronic control device 14 may estimate a tendency of an occurrence time, an occurrence place or the like of the pests, by using the learning model 30 (refer to a portion surrounded by one-dot chain line B in FIG. 1). The electronic control device 14 stores the estimation result of the tendency as data. The electronic control device 14 may correct, for example, the application amount of the agrochemical 20, by using the estimation result, when the agrochemical 20 is to be applied next time. Accordingly, it is possible to grasp the tendency of the pests generated in the object 102. The amount of the agrochemical 20 to be sprayed can be varied.

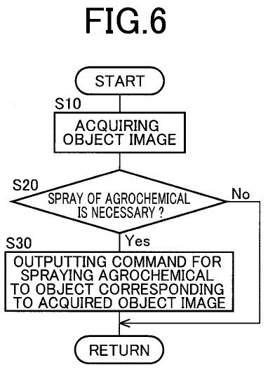

FIG. 6 is a flowchart for explaining a main part of a control routine executed by the electronic control device 14, for efficiently spraying the agrochemical 20. This control routine is repeatedly executed during running of the vehicle 10, for example.

As shown in FIG. 6, in step (hereinafter, step will be omitted) S10, the object image PICs included in the image information Ipic is acquired from the photographing device 12. Next, in S20, it is determined whether or not the spray of the agrochemical 20 is necessary based on the object image PICs. When the determination of this S20 is negative, this control routine is ended. When the determination of the S20 is affirmed, the spraying command signal Sspr for applying the agrochemical 20 to the object 102 corresponding to the acquired object image PICs is output to the spraying device 16 in S30.

As described above, according to the present embodiment, since the vehicle 10 is provided with the photographing device 12, the electronic control device 14, and the spraying device 16, estimation and control of the pests can be performed at the same time. Since the vehicle 10 is not a flying object, for example, energy consumption associated with an increase in the mounted weight of the vehicle 10 is suppressed. In addition, since the photographing device 12 takes an image from the lower end to the upper end of the object 102 in the vertical direction, the vehicle 10 can estimate and control the pests at the same time even where the agrochemical 20 is sprayed to a tall object 102 such as a fruit tree. At this time, for example, it is possible to find the pests that occur in a low position in the tall object 102. Therefore, the agrochemical 20 can be sprayed efficiently.

Further, according to the present embodiment, when the agrochemical 20 is sprayed, the car 10 is cause to run at the above-described lower running speed Vmin that is the lower one of the highest value Vpicmax of the predetermined range Vpic of the running speed V and the highest value Vsprmax of the predetermined range Vspr of the running speed V, as the upper limit of the running speed V. Thus, the clear object image PICs from which the necessity of the spray of the agrochemical 20 can be determined and the proper spray of the agrochemical 20 can be performed with the maximum efficiency. Since the vehicle 10 is not a flying object, it is energy efficient also in a low speed operation, for example.

In addition, according to the present embodiment, the object image PICs is corrected by the electronic control device 14 based on the difference between the reference situation STf and the actual situation STs in which the object 102 was photograph to acquire the object image PICs. Further, the electronic control device 14 makes the determination as to whether or not the agrochemical 20 needs to be sprayed to the object 102, based on the corrected object image PICsc. Accordingly, it is possible to acquire the object image PICs that is less likely to be affected by the actual situation STs such as the brightness around the vehicle 10 and the type of the object 102, and it is possible to appropriately perform the estimation and the control of the pests.

According to the present embodiment, the electronic control device 14 determines whether or not the spray of the agrochemical 20 is necessary by applying the object image PICs to the learning model 30. Therefore, it is possible to determine whether or not the spray of the agrochemical 20 is necessary by a visual difference close to an artificial determination method.

In addition, according to the present embodiment, by applying the object image PICs to the learning model 30 by the electronic control device 14, the type of the pests and the progress degree of the damage caused by the pests are determined, and the type and the required amount of the agrochemical 20 are determined based on the type of the pests and the progress degree of the damage caused by the pests. Thus, the kind and dilution ratio of the agrochemical effective for the pests are determined. When the type of the agrochemical 20 mounted on the vehicle 10 is not effective for the pests, for example, the spray of the agrochemical 20 can be stopped to reduce the amount of the agrochemical 20 to be used.

Although the embodiment of the present invention has been described in detail with reference to the drawings, the present invention is also applicable to other embodiments.

For example, in the above-described embodiment, whether or not the spray of the agrochemical 20 is necessary is determined by using the color hue difference Dt, but the present invention is not limited to this mode. For example, whether or not the spray of the agrochemical 20 is necessary may be determined by using the growth state or health state of the object 102. As described above, various methods can be used to determine whether or not the agrochemical 20 needs to be sprayed.

In the above-described embodiment, the photographing device 12 includes the detection sensor 28 and detects the length or height of the object 102 in the vertical direction, but the invention is not limited to this mode. For example, the photographing device 12 may recognize an imaging region by processing the image PIC and photograph the object 102 from the lower end to the upper end of the object 102 in the vertical direction. That is, the photographing device 12 does not necessarily need to detect the vertical length or height of the object 102 around the vehicle 10. In this case, the photographing device 12 does not need to include the detection sensor 28. In short, the photographing device 12 only needs to be able to photograph at least from the lower end to the upper end of the object 102 in the vertical direction during running of the vehicle 10 when the agrochemical 20 is sprayed.

Further, in the above-described embodiment, the spraying device 16 is provided in the rear portion of the vehicle 10, but the invention is not limited to this mode. For example, the spraying device 16 may be provided on a carriage connected to the rear portion of a main body of the vehicle 10 in the longitudinal direction. The carriage is pulled by the main body of the vehicle 10 to run integrally with the main body of the vehicle 10, so as to constitute a part of the vehicle 10. Accordingly, the spraying device 16 provided on the carriage may be interpreted to be provided in the vehicle 10.

Further, in the above-described embodiment, the provision of the photographing device 12 is not limited to the front portion of the vehicle 10, and the provision of the spraying device 16 is not limited to the rear portion of the vehicle 10. In short, any configuration may be employed as long as the agrochemical 20 can be applied to the object 102 determined to require spray of the agrochemical 20.

In the above-described embodiment, where the learning model 30 is a predetermined learned model indicating the relationship between the data of the image PIC and the necessity of the spray of the agrochemical 20, the teaching signals for the input layer in FIG. 5 does not need to include the data of the situation ST.

It should be noted that the above-described embodiment is merely one embodiment, and the present invention can be implemented in a mode in which various changes and improvements are added based on the knowledge of those skilled in the art.

### NOMENCLATURE OF ELEMENTS

10: vehicle
12: photographing device
14: electronic control device (control device)
16: spraying device
20: agrochemical
30: learning model
102: object to be controlled
PIC: image
PICb: predetermined reference image
PICs: object image (image used for the determination as to whether or not the agrochemical needs to sprayed to the object)
PICsc: corrected object image (image corrected based on the difference)

What is claimed is:

1. A vehicle for spraying an agrochemical to an object to be controlled, the vehicle comprising:
a photographing device configured to photograph the object around the vehicle;
a control device configured to make a determination as to whether or not the agrochemical needs to sprayed to the object, based on an image of the object acquired when the object was photographed; and
a spraying device configured to spray the agrochemical to the object when it is determined that the agrochemical needs to be sprayed to the object; and
wherein the photographing device is configured to photograph the object from a lower end of the object to an upper end of the object in a vertical direction of the object.

2. The vehicle according to claim 1,
wherein, when the spraying device sprays the agrochemical to the object, the vehicle is configured to run at a running speed that is not higher than a lower one of a first maximum speed value and a second maximum value,
wherein the first maximum speed value is a highest value of a clear-image enabling range which is a range of a running speed of the vehicle and which enables the photographing device to acquire the image clearly to make the determination based on the image, and
wherein the second maximum speed value is a highest value of an appropriate-agrochemical-spray enabling range which is a range of the running speed of the vehicle and which enables the spraying device to appropriately spray the agrochemical to the object.

3. The vehicle according to claim 1,
wherein the control device is configured to correct the image based on a difference between a reference situation in which the object was photographed to acquire a reference image and an actual situation in which the object was photographed to take the image that is to be used for the determination as to whether or not the agrochemical needs to be sprayed to the object, and
wherein the control device is configured to make the determination based on the image corrected based on the difference.

4. The vehicle according to claim 1,
wherein the control device is configured to make the determination as to whether or not the agrochemical needs to sprayed to the object, by applying data of the image used for the determination, to a predefined learning model which is established by a supervised learning through a machine learning and which indicates a relationship between the data of the image and necessity of spray of the agrochemical to the object.

5. The vehicle according to claim 4,
wherein the learning model further indicates a relationship among the data of the image, a type of pests that have occurred in the object, and a degree of progress of damage caused by the pests, and
wherein the control device is configured to determine the type of the pests and the degree of the progress of the damage, by applying the data of the image used for the determination as to whether or not the agrochemical needs to sprayed to the object, to the learning model, and to determine a type and a required amount of the agrochemical based on the type of the pests and the degree of the progress of the damage.
